(19) United States
(12) Patent Application Publication
(10) Pub. No.: US 2025/0013041 A1
(43) Pub. Date: Jan. 9, 2025

(54) PROJECTOR COMPENSATION WITH INCOUPLER GRATING LINE OFFSET

(71) Applicant: Applied Materials, Inc., Santa Clara, CA (US)

(72) Inventors: Evan WANG, Palo Alto, CA (US); David Alexander SELL, Santa Clara, CA (US); Kevin MESSER, Mountain View, CA (US)

(21) Appl. No.: 18/763,328

(22) Filed: Jul. 3, 2024

Related U.S. Application Data
(60) Provisional application No. 63/511,961, filed on Jul. 5, 2023.

(51) Int. Cl. G02B 27/01; G02B 6/34

(52) U.S. Cl. CPC G02B 27/0101; G02B 6/34; G02B 2027/011; G02B 2027/0123

(57) ABSTRACT

Certain aspects of the present disclosure include an optical device. The optical device generally includes an in-coupler (IC) configured to receive light from a projector, where the IC includes at least one grating line offset (GLO) associated with one or more phase deviations of the light from the projector. The device also includes a waveguide and an output coupler (OC), where the IC is configured to redirect the light from the projector to the OC through the waveguide.

### CROSS-REFERENCE TO RELATED APPLICATION

The present application for patent claims the benefit of priority to U.S. Provisional Patent Appl. No. 63/511,961, filed Jul. 5, 2023, which is hereby incorporated by reference herein in its entirety.

### BACKGROUND

### Field

Certain aspects of the present disclosure generally relate to a waveguide display. More particularly, the present disclosure provides a waveguide having an in-coupler implemented with projector compensation.

### Description of the Related Art

Augmented reality (AR) is a technology that blends virtual and physical worlds to provide users with immersive experiences. Creating a virtual image that appears integrated with the real environment is important for the AR display. AR may be implemented with a waveguide including an in-coupler (IC) and an out-coupler (OC), where the IC redirects light from a projector towards an OC, and the OC redirects light towards a user's eye.

### SUMMARY

Certain aspects of the present disclosure include an optical device. The optical device generally includes an in-coupler (IC) configured to receive light from a projector, where the IC includes at least one grating line offset (GLO) associated with one or more phase deviations of the light from the projector. The device also includes a waveguide and an output coupler (OC), where the IC is configured to redirect the light from the projector to the OC through the waveguide.

Certain aspects of the present disclosure include a method for optical signal processing. The method generally includes receiving, via an IC, light from a projector. The method also includes applying at least one phase shift to the light via the IC, where, to apply the at least one phase shift, the IC includes at least one GLO associated with one or more phase deviations of the light from the projector. The method may also include redirecting, via the IC, the light from the projector to an OC through a waveguide.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of scope, and may admit to other equally effective embodiments.

FIG. 1 illustrates an optical device having a waveguide and an in-coupler (IC), in accordance with certain aspects of the present disclosure.

FIG. 2A illustrates phase deviations of light from a projector.

FIG. 2B illustrates a GLO implemented for an IC to reduce effects of phase deviations in light from a projector, in accordance with certain aspects of the present disclosure.

FIG. 3 is a flow diagram illustrating example operations for optical signal processing, in accordance with certain aspects of the present disclosure.

To facilitate understanding, identical reference numerals have been used, where possible, to designate identical elements that are common to the figures. It is contemplated that elements and features of one embodiment may be beneficially incorporated in other aspects without further recitation.

### DETAILED DESCRIPTION

An in-coupler (IC) of a waveguide combiner diffracts light from a projector into total internal reflection (TIR) (e.g., total internal reflection within a medium, such as the waveguide). Some aspects are directed towards shifting the grating lines across the IC, resulting in a spatially varying phase applied to the diffracted light from the projector. The phase shift may be used to compensate for the effects of imperfections in the projector output. As used herein, compensation refers to any reduction in the effects of the imperfections and does not require complete compensation for such effects.

Augmented reality (AR) waveguide combiners may be designed assuming the projector output is a plane wave with a flat wavefront. This is often not the case in real projectors, and any deviations from the flat wavefront may degrade the system's modulation transfer function (MTF) or sharpness. MTF refers to the optical device's capability to transfer an object's contrast from an input of the optical device to an output of the optical device. From the user's perspective, the deviations may manifest as a blurry virtual image and inhibit the readability of small text or lines. Certain aspects reduce the effects of such deviations from the flat wavefront by implementing a grating line offset (GLO) for an IC for the waveguide.

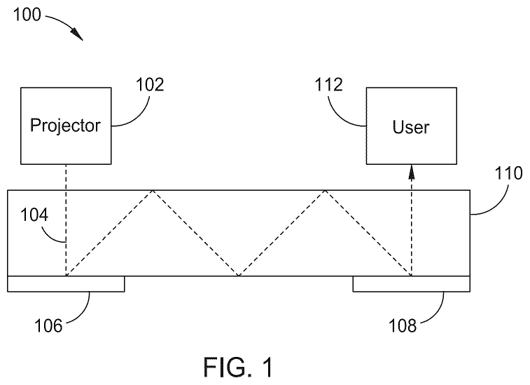

FIG. 1 illustrates an optical device 100 having a waveguide 110 and an IC 106, in accordance with certain aspects of the present disclosure. As shown, light 104 may be received from a projector 102. The light 104 may be directed towards an IC 106. The IC 106 redirects the light into TIR within the waveguide 110 until the light 104 reaches an OC 108. The OC 108 may redirect the light toward a user 112, as shown.

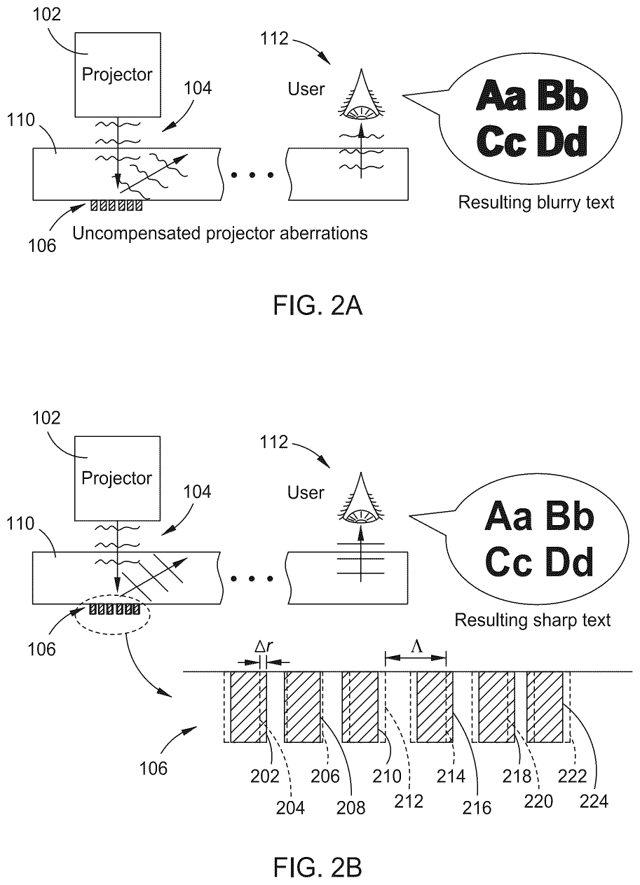

FIG. 2A illustrates phase deviations of light 104 from a projector 102. In other words, projector aberrations may result in phase deviations, as shown. Such phase deviations are directed from the projector 102, to the IC 106, and eventually to the user 112 where such phase deviations are experienced by the user as blurriness in an image, as shown.

FIG. 2B illustrates a GLO implemented for the IC 106 to reduce the effects of such phase deviations in the light from the projector 102, in accordance with certain aspects of the present disclosure. As shown, light received from the projector by the IC 106 has phase deviations. Such phase deviations are reduced via the GLO implemented for the IC 106. As shown, the light redirected from the IC may have a flat wavefront due to the GLO of the IC 106.

The GLO used for compensation of phase deviation depends on the projector output. The phase deviation from a flat wavefront may be measured across a pupil at multiple wavelength and field of view (FOV) points. The measurements may be used to identify the GLO for each grating line. In some aspects, a compensation map may be identified, including the average of the wavefront deviations over wavelength and FOV. In some aspects, the correction map may be identified based on different weights associated with different wavelengths and FOV points based on a contribution to the MTF. For example, a first wavelength may be given a higher weight than a second wavelength if the first wavelength contributes more to the MTF than the second wavelength. Once a compensation map is identified, a phase offset (Δϕ) may be calculated for one or more grating lines of the IC 106. For example, the phase offset may be identified for grating lines across the IC given by expression:

$$Δ r = \frac{Λ \cdot Δϕ ( r )}{2 π m}$$

where Δr is the GLO, and Δϕ(r) is the phase offset for the light associated with the GLO, and where m is a non-zero integer corresponding to a diffraction order associated with a diffraction event of the IC. Grating lines 204, 206, 212, 214, 220, and 222 with equal periodicity (Λ) are shown, and grating lines 202, 208, 210, 216, 218, 224 with GLO are shown. GLO refers to any offset in the placement of grating lines relative to where the grating lines would be if the grating lines were periodic (had equal periodicity). For example, the GLO may refer to the distance between grating line 212 and grating line 210. As shown, the GLO may be positive, such as where grating line 202 is shifted to the right compared to grating line 204, or may be negative, such as where grating line 210 is shifted to the left compared to grating line 212.

Other techniques for imparting a phase shift to the projector output may include using external optics or varying the depth and/or duty cycle of the IC grating. Compared to any form of external optics, grating line offset can be designed into the IC grating with little to no additional costs (e.g., product costs or area). Compared to a spatially varying depth or duty cycle in the IC grating, phase imparted by grating line offset may not affect the light that hits the grating again after diffracting into TIR. Such secondary phase shifts (e.g., spatially varying depth or duty cycle) can potentially introduce further aberrations to the wavefront. Additionally, variable geometries can introduce spatially varying diffraction efficiencies. Thus, imparting phase shift using GLO for the IC provides a more efficient technique for reducing the effects of projector aberrations as compared to other described techniques.

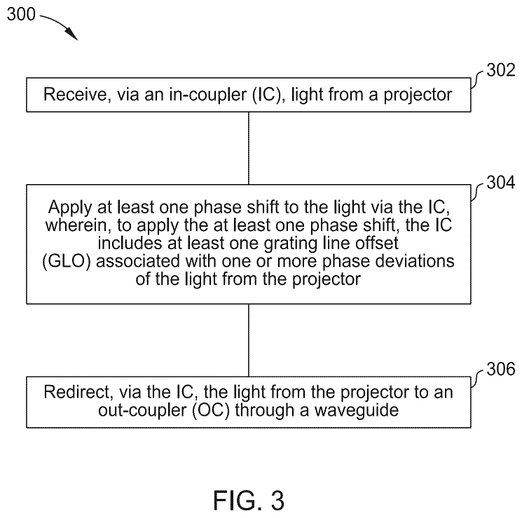

FIG. 3 is a flow diagram illustrating example operations 300 for optical signal processing, in accordance with certain aspects of the present disclosure. The operations 300 may be performed by an optical device, such as the optical device 100.

At block 302, the optical device may receive, via an IC (e.g., IC 106), light from a projector (e.g., projector 102). At block 304, the optical device may apply at least one phase shift (e.g., Δϕ) to the light via the IC. To apply the at least one phase shift, the IC may include at least one GLO (e.g., Δr) associated with one or more phase deviations of the light from the projector. In some aspects, the at least one GLO may include different GLOs applied to at least two grating lines of the IC. The at least one GLO may be determined based on an average of the phase deviations of the light. In some aspects, different weights may be applied for different wavelengths of the light or FOVs associated with the optical device. The at least one GLO of the IC may be determined based on the different weights. The different weights may be determined based on the contribution of the different wavelengths or FOVs to a modulation transfer function of the optical device.

In some aspects, the at least one GLO may include an offset of a grating line (e.g., grating line 202) of the IC from a grating line (e.g., grating line 204) of an IC having periodic grating lines. The at least one GLO may be associated with a determined phase shift to be applied to the light to reduce an effect of the one or more phase deviations in one or more image metrics. At block 306, the optical device may redirect, via the IC, the light from the projector to an OC (e.g., OC 108) through a waveguide (e.g., waveguide 110).

While the foregoing is directed to aspects of the present disclosure, other and further aspects of the disclosure may be devised without departing from the basic scope thereof, and the scope thereof is determined by the claims that follow.

1. An optical device, comprising:
an in-coupler (IC) configured to receive light from a projector, wherein the IC includes at least one grating line offset (GLO) associated with one or more phase deviations of the light from the projector;
a waveguide; and
an output coupler (OC), wherein the IC is configured to redirect the light from the projector to the OC through the waveguide.

2. The optical device of claim 1, wherein the at least one GLO comprises different GLOs applied to at least two grating lines of the IC.

3. The optical device of claim 1, wherein the at least one GLO is determined based on an average of the phase deviations of the light.

4. The optical device of claim 1, wherein different weights are applied for different wavelengths of the light or field of views (FOVs) associated with the optical device, and wherein the at least one GLO of the IC is determined based on the different weights.

5. The optical device of claim 4, wherein the different weights are determined based on a contribution of the different wavelengths or FOVs to a modulation transfer function of the optical device.

6. The optical device of claim 1, wherein the at least one GLO is an offset of a grating line of the IC from a grating line of an IC having periodic grating lines.

7. The optical device of claim 1, wherein the at least one GLO is associated with a determined phase shift to be applied to the light to reduce effects of the one or more phase deviations in one or more image metrics.

8. A method for optical signal processing, comprising:
receiving, via an in-coupler (IC), light from a projector;
applying at least one phase shift to the light via the IC, wherein, to apply the at least one phase shift, the IC includes at least one grating line offset (GLO) associated with one or more phase deviations of the light from the projector; and
redirecting, via the IC, the light from the projector to an out-coupler (OC) through a waveguide.

9. The method of claim 8, wherein the at least one GLO comprises different GLOs applied to at least two grating lines of the IC.

10. The method of claim 8, wherein the at least one GLO is determined based on an average of the phase deviations of the light.

11. The method of claim 8, wherein different weights are applied for different wavelengths of the light or field of views (FOVs) associated with an optical device, and wherein the at least one GLO of the IC is determined based on the different weights.

12. The method of claim 11, wherein the different weights are determined based on a contribution of the different wavelengths or FOVs to a modulation transfer function of the optical device.

13. The method of claim 8, wherein the at least one GLO comprises an offset of a grating line of the IC from a grating line of an IC having periodic grating lines.

14. The method of claim 8, wherein the at least one GLO is associated with a determined phase shift to be applied to the light to reduce an effect of the one or more phase deviations in one or more image metrics.

15. An augmented reality (AR) device, comprising:
a projector;
an in-coupler (IC) configured to receive light from the projector, wherein the IC includes at least one grating line offset (GLO) associated with one or more phase deviations of the light from the projector;
a waveguide; and
an output coupler (OC), wherein the IC is configured to redirect the light from the projector to the OC through the waveguide.

16. The AR device of claim 15, wherein the at least one GLO comprises different GLOs applied to at least two grating lines of the IC.

17. The AR device of claim 15, wherein the at least one GLO is determined based on an average of the phase deviations of the light.

18. The AR device of claim 15, wherein different weights are applied for different wavelengths of the light or field of views (FOVs) associated with the AR device, and wherein the at least one GLO of the IC is determined based on the different weights.

19. The AR device of claim 18, wherein the different weights are determined based on a contribution of the different wavelengths or FOVs to a modulation transfer function of the AR device.

20. The AR device of claim 15, wherein the at least one GLO is an offset of a grating line of the IC from a grating line of an IC having periodic grating lines.
